(19) United States
(12) Patent Application Publication
(10) Pub. No.: US 2026/0287159 A1
(43) Pub. Date: Sep. 24, 2026

(54) Supply device for fastening to a planar carrier arrangement having electrical conductor tracks

(71) Applicant: H4X e.U., Graz (AT)

(72) Inventor: Andreas HIERZER, Graz (AT)

(73) Assignee: H4X e.U., Graz (AT)

(21) Appl. No.: 19/573,539

(22) Filed: Mar. 20, 2026

(30) Foreign Application Priority Data
Mar. 20, 2025 (AT) A50191/2025

(51) Int. Cl. F21V 23/02; F21V 21/002

(52) U.S. Cl. CPC F21V 23/02; F21V 21/002

(57) ABSTRACT

A supply device fastens to a planar carrier arrangement having electrical conductor tracks. A housing, contacting elements, and an arrangement of electrical or electronic components is electrically coupled to the contacting elements. The supply device is coupled to an electrical consumer for the supply. The contacting elements are provided for piercing into a surface of the carrier arrangement. The contacting elements can be brought into a non-contacting position, in which they are received in the housing. The contacting elements are brought into a contacting position and extended out of the housing by means of manual action on the supply device in order to pierce into the surface of the carrier arrangement by means of the contacting elements to bring the contacting elements into contact with the conductor tracks. The supply device includes a safety arrangement in which an extension of the contacting elements is mechanically prevented.

### FIELD OF THE INVENTION

The invention relates to a supply device for fastening to a planar carrier arrangement having electrical conductor tracks. In particular, the supply device can be used in this case to supply an electrical consumer.

### TECHNICAL BACKGROUND

The fastening of electrical consumers, for example, to a wall of a room, and the supply of these consumers, in each case starting from the wall, via an assigned cable laid in or on the wall, is widespread. The attachment of electrical consumers to a ceiling of a room and their supply by means of an associated cable in or on the ceiling is also known. The electrical consumers can serve a wide variety of functions, for example an illumination of the room, but alternatively many other purposes. However, the flexibility of the arrangement and use of such consumers is often particularly considerably limited.

WO 2023 / 016 661 A1 describes a surface power supply in the low-voltage range on an inner wall of a room. For this purpose, a carrier system having a magnetic or magnetizable holding layer and having a plurality of surface conductor tracks running parallel to one another is provided. Various functional objects, such as lamps, can be held on the wall and supplied with electrical energy. The functional objects are equipped with one or more current collectors, which are likewise described in WO 2023/016 661 A1, in order to realize the electrical supply thereof. In order to contact the surface conductor tracks, the current collectors each comprise contacting elements that are embodied in the form of a needle, wherein it is provided that the contacting elements penetrate into the carrier system. The current collector should be reversibly fastenable and can be used regardless of position and orientation on the planar carrier system.

Although the approach described in WO 2023/016 661 A1 already offers an advantageous, safe and flexible way of supplying electrical consumers of functional objects, it would be desirable, against this background, to have a supply device that is even further improved, in particular with regard to its handling.

### SUMMARY OF THE INVENTION

It is therefore an object of the present invention to provide a supply device for fastening to a planar carrier arrangement, which is even more improved in terms of its handling, in particular is even easier and more pleasant to handle.

In accordance with the invention, this object is achieved by virtue of a supply device having the features of Claim 1.

Accordingly, a supply device is suggested for fastening to a planar carrier arrangement having electrical conductor tracks, wherein the supply device comprises a housing, contacting elements and an arrangement of electrical and/or electronic components that is electrically coupled to the contacting elements. The supply device can be or is coupled to an electrical consumer for the supply thereof.

In the case of the supply device in accordance with the invention, the contacting elements are each provided for piercing into a surface of the carrier arrangement and are each embodied as pointed and/or sharp. The contacting elements can be brought into a non-contacting position, in which the contacting elements are received in the housing. In addition, the contacting elements can be brought into a contacting position and for this purpose can be extended out of the housing by means of manual action on the supply device in order to pierce into the surface of the carrier arrangement by means of the contacting elements and to bring at least two of the contacting elements into contact with in each case one of the conductor tracks.

In accordance with the invention, the supply device comprises at least one safety arrangement, by means of which an extension of the contacting elements is mechanically prevented in a blocking configuration thereof.

One idea of the present invention is to receive the contacting elements in the housing in the non-contacting position, to extend them out of the housing for contacting by means of the piercing into the surface, and to prevent this extension by means of the safety arrangement in its blocking configuration. An unintentional extension of the pointed and/or sharp contacting elements can thus be prevented. In this manner, the handling of the supply device, in particular if it is not yet attached to the carrier arrangement and also during attachment, becomes even more pleasant and safer. By preventing the contacting elements from being extended by means of the safety arrangement, contact with the contacting elements, in particular their pointed and/or sharp regions, is avoided during manual handling both with hands and fingers and with objects. In this manner, the supply device can be handled easily, comfortably and safely by an operator or installer. In addition, damage to the surface of the carrier arrangement or other objects due to mechanical contact with the contacting elements, such as scratching or the like, can also be avoided.

Advantageous embodiments and developments of the invention are disclosed in the further subordinate claims and also the description with reference to the figures.

In one embodiment, the safety arrangement can be brought manually into a release configuration in which the extension of the contacting elements is rendered possible. In this way, the safety arrangement can be actuated in a simple, reliable and safe manner in order to then intentionally extend the contacting elements.

In accordance with one development, the supply device includes a restoring device, which is embodied so as to directly or indirectly pre-stress the contacting elements at least in their contacting position for an automatic assumption of the non-contacting position. In this manner, it can be achieved, for example, that the contacting elements are automatically retracted into the housing when the supply device is intentionally removed from the carrier arrangement by an operator or installer, or also when the supply device is detached from the carrier arrangement in an unintentional manner, such as by accidental impact, impact or accidental other excessive force. Contact of the contacting elements with body parts such as fingers or palms when lifting the supply device, for example from the base, as well as additional damage, for example to the base surface, are thereby avoided in a reliable and safe manner. This makes the handling of the supply device even more pleasant.

In particular, it can be provided that the extension of the contacting elements by means of the manual action includes overcoming at least one spring force. In this manner, for example, a pre-stressing of the contacting elements in the direction of the non-contacting position thereof can be achieved in a simple and expedient manner with the aid of the manual action.

In one embodiment, the safety arrangement is configured so as to automatically assume the blocking configuration when the contacting elements are located in their non-contacting position. In this manner, it is possible to ensure even more reliably that the contacting elements cannot be extended inadvertently, which further improves the handling of the supply device.

In accordance with one embodiment, it is provided that the housing comprises an inner housing part and an outer housing part, wherein the inner and outer housing parts are coupled to one another so as to be movable relative to one another and the contacting elements can be extended out of the housing by a movement of the inner and outer housing parts relative to one another by means of the manual action. In this way, the contacting elements can be extended manually in a simple, clear manner. In addition, this allows a force to be applied to the contacting elements both effectively and safely for piercing.

In one development, the contacting elements can be displaced together with the inner housing part relative to the outer housing part, in particular along an axial direction of the housing. This can contribute to a comparatively simple structure of the supply device.

In particular, the inner housing part protrudes in sections from the outer housing part in the non-contacting position of the contacting elements. This also contributes to a simple construction of the supply device, makes it possible to detect the prevailing retracted/extended state of the contacting elements also on the housing, and can also contribute to facilitating the implementation of the safety arrangement.

In one embodiment, the contacting elements can be extended out of the outer housing part on an end face thereof. Such an end face can be advantageously suitable, for example, for bearing against the carrier arrangement.

In accordance with one development, the safety arrangement comprises a manually actuable blocking and release mechanism, the actuation of which brings the safety arrangement into its release configuration and renders it possible to move the inner housing part relative to the outer housing part, in particular to move it into the outer housing part, preferably to press it in, more preferably to press it in such a manner that the inner housing part is essentially completely received in the outer housing part. The mode of operation of such a safety arrangement is easy to understand for an operator or installer, which also contributes to a simple and pleasant handling of the supply device.

In one embodiment, the blocking and release mechanism is embodied with at least one spring-loaded, movable blocking element, by means of which a movement of the inner housing part relative to the outer housing part, in particular a manual pressing of the inner housing part into the outer housing part, can be blocked. In this case, the blocking element can be moved manually against the spring load for release. In this manner, a simple, effective and space-saving structure of the blocking and release mechanism is achieved. In particular, the blocking element can also assume a blocking position in an effective manner automatically by means of the spring load in order to realise the blocking configuration.

In accordance with yet a further development, the blocking and release mechanism comprises at least two such blocking elements which are arranged such that they can be moved in a spring-loaded manner on a circumference of the inner housing part and are embodied as pressure actuation elements, in particular two such blocking elements which are arranged on opposite sides of the inner housing part. In this manner, an unintentional extension of the contacting elements can be prevented even more reliably. In order to bring the safety arrangement into its release configuration, the at least two pressure actuation elements are actuated in particular by manual pressure, preferably simultaneously. The release of the safety arrangement thus advantageously requires a targeted manual intervention, as a result of which it is possible to better avoid an unintentional release.

In one embodiment, the blocking element(s) is/are arranged on an end section of the inner housing part, which protrudes from the outer housing part in a state in which the contacting elements are located in their non-contacting position, and in this embodiment protrudes away from the inner housing part over an edge of the outer housing part in the non-actuated state. This renders it possible for the movement of the inner housing part and the extension of the contacting elements to be blocked in a simple and effective manner with the aid of the blocking element or the blocking elements if no external force is applied to the blocking element(s) for actuation.

In particular, the blocking element(s) can each be embodied as a blocking body which is/are mounted on or in the inner housing part such that it/they can be displaced essentially radially with respect to the inner housing part and is/are spring-loaded by a spring element for protrusion in the direction radially outward.

In one embodiment, the inner housing part comprises guide projections, which interact with corresponding guide recesses of the outer housing part and thereby guide the inner housing part during its movement relative to the outer housing part during the extension or retraction of the contacting elements. This contributes to realising a defined relative movement of the inner and outer housing part reliably, uniformly and without jamming and stiffness, which in turn advantageously contributes to a good handling of the supply device.

The inner housing part and the outer housing part can be spring-loaded relative to one another, in particular by means of at least one axially acting spring that is arranged between the housing parts. In this manner, it can be achieved, for example, that the contacting elements automatically assume their non-contacting position, while their extension includes a targeted action against the spring force of the axially acting spring.

In one embodiment, the arrangement of electrical and/or electronic components is provided on a circuit board or a plurality of circuit boards, wherein the circuit board(s) are fastened to the inner housing part and are received in particular in the inner housing part. Thus, during the retraction and extension of the contacting elements, a relative movement of these contacting elements relative to the electrical and/or electronic components can advantageously be avoided, which contributes to implementing electrical connection paths in a simple manner.

In one development, the supply device comprises a fastening device, which renders it possible for the supply device to be detachably fixed to the carrier arrangement, in particular in a state in which the contacting elements are located in the contacting position. In addition to the electrical coupling to the carrier arrangement, a mechanical fastening can thus also advantageously be achieved.

In a further development, the fastening device is embodied with one or more magnets, in particular with one or more permanent magnets, which can interact with a magnetizable or magnetized material on or in the surface of the carrier arrangement. This renders possible a quick and easy fastening, which is easily detachable and avoids damage or aesthetic impairment of the surface of the carrier arrangement.

In particular, the magnets of the fastening device can be fastened to the inner housing part. In this manner, the magnets can simultaneously be moved closer to the carrier arrangement when the contacting elements are being extended and interact with the magnetized or magnetizable material. Thus, by moving the magnets with the inner housing part, the contacting elements can be held even more reliably in the carrier arrangement after they have been inserted into it.

In a preferred embodiment, the housing comprises a round, in particular circular, outer contour. This can advantageously render possible a coupling to the consumer in many positions. In particular, in the case of a circular outer contour, the consumer can be coupled to the supply device, for example, in a simple manner such that it can be rotated about the supply device.

The outer housing part is preferably embodied with an essentially circular-cylindrical outer shape or a slightly truncated cone outer shape.

In accordance with one development, when the contacting elements are located in their contacting position, the housing can be received in a round recess of the consumer. In particular, it can be provided that the housing that is received in the round recess of the consumer is enclosed by the consumer in a circumferential direction of the housing and overlaps the consumer in an axial direction of the housing or is received essentially completely in the round recess of the consumer in the axial direction. This renders possible a reliable coupling and mechanical orientation of the consumer relative to the supply device. In addition, the supply device can be concealed in the recess in an aesthetically advantageous manner.

The housing of the supply device can in particular be provided with recesses, through which the contacting elements can be extended by means of the manual action.

In one embodiment, the contacting elements are embodied as contact needles. This renders possible an effective, reliable piercing for producing a contact with conductor tracks of the carrier arrangement.

It is preferred that the electrical conductor tracks of the carrier arrangement are covered by one or more cover layer(s) of the carrier arrangement and the contacting elements are each embodied for piercing the cover layer or cover layers. Thus, the conductor tracks are covered aesthetically and reliably, wherein at the same time a reliable contacting is possible.

In particular, the electrical conductor tracks that are arranged next to one another comprise an alternating polarity when the voltage supply is activated; in other words, the polarity of the conductor tracks regularly changes from one conductor track to the next transversely to their direction of extension.

In one embodiment, it is provided that the supply device comprises a first electrical contact device, which is formed with the contacting elements, and comprises a second electrical contact device for contacting and supplying the consumer. This contributes to a simple to produce and detachable electrical coupling of the supply device and consumer.

In accordance with one development, the second contact device is embodied with concentric circular or annular contacts, which can each be contacted by means of a resilient pressure contact of the consumer, in particular in such a manner that an unhindered rotation of the consumer about the housing of the supply device is rendered possible without interrupting the power supply of the consumer.

In other developments, the second contact device can be embodied with a component of a plug/socket connection, for example with a socket for receiving a low-voltage plug, for example a coaxial low-voltage plug connector or DC plug, or with a USB socket, in particular a USB-C socket.

In one embodiment, the inner housing part is produced in an injection moulding process or a 3D printing process.

In one embodiment, the outer housing part is produced in an injection moulding process or a 3D printing process.

The inner and/or outer housing part can be formed in particular with a plastic material.

In accordance with one development, the electrical consumer can be a dimmable lamp or a non-dimmable lamp.

In accordance with a further development, the electrical consumer can be a charging device or a display device or a power source for a further consumer. In an alternative embodiment, the supply device can serve as a charger, for example for a smartphone or a laptop.

The above embodiments and developments of the invention can be combined in any manner as desired, provided this is expedient. Further possible embodiments, developments and implementations of the present invention also include combinations, not explicitly mentioned, of features of the invention described above or below with regard to the exemplary embodiments. In particular, the person skilled in the art will also add individual aspects as improvements or additions to the respective basic form of the present invention.

### BRIEF DESCRIPTION OF THE DRAWINGS

The invention is further explained hereinunder with reference to exemplary embodiments illustrated in the figures of the drawing. In the drawings:

FIG. 1 illustrates an exemplary planar carrier arrangement comprising electrical conductor tracks;

FIG. 2 illustrates a supply device in accordance with an exemplary embodiment that can be fastened to the carrier arrangement of FIG. 1, in a perspective view;

FIG. 3 illustrates the carrier arrangement in accordance with FIG. 1, the supply device in accordance with FIG. 2 fastened to the carrier arrangement, and an electrical consumer, which is in the form of a lighting device, is fastened to the carrier arrangement and is coupled to the supply device for electrical supply, in a central section;

FIG. 4 illustrates the supply device in accordance with the exemplary embodiment of FIG. 2 in an exploded view;

FIG. 5 illustrates a first populated circuit board of the supply device in accordance with the exemplary embodiment of FIG. 2, in perspective from a first side, with contacting elements of a first electrical contact device arranged thereon;

FIG. 6 illustrates the first populated circuit board of FIG. 5, in perspective from a second side opposite the first side;

FIG. 7 illustrates a second populated circuit board of the supply device in accordance with a variant of the exemplary embodiment of FIG. 2, in perspective from a side provided with a second electrical contact device;

FIG. 8 illustrates a view of the supply device in accordance with the exemplary embodiment of FIG. 2 from a side that faces the carrier arrangement after the supply device has been fastened to the latter;

FIG. 9 illustrates a view of the supply device in accordance with the exemplary embodiment of FIG. 2 in a section IX-IX, as indicated in FIG. 8, in a state with extended contacting elements;

FIG. 10 illustrates a view of the supply device in accordance with the exemplary embodiment of FIG. 2 in a central longitudinal section in a state with retracted contacting elements; and

FIG. 11 illustrates a view of the supply device in accordance with the exemplary embodiment of FIG. 2 in a central longitudinal section XI-XI, as indicated in FIG. 8, in a state with extended contacting elements, together with sections of the carrier arrangement of FIG. 1 and a schematically illustrated consumer.

The enclosed drawings are intended to provide a further understanding of the embodiments of the invention. They illustrate embodiments and are used in connection with the description of the explanation of principles and concepts of the invention. Other embodiments and many of the advantages that are mentioned arise with regard to the drawings.

The elements of the drawings are not necessarily illustrated to scale with one another.

In the figures, identical, functionally identical and identically acting elements, features and components are in each case provided with the same reference numerals, unless stated otherwise.

### DESCRIPTION OF EXEMPLARY EMBODIMENTS

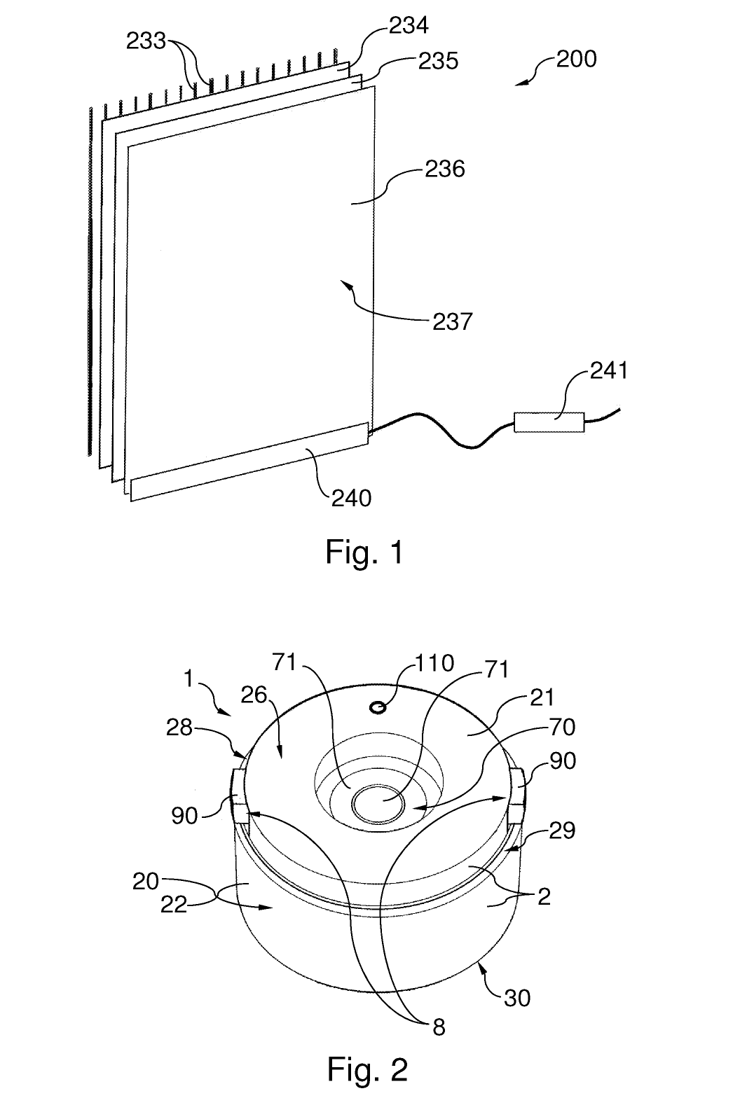

FIG. 1 illustrates a planar carrier arrangement 200, which is formed with a plurality of layers 233-236 and, by way of example, expands in one plane, in an exploded view. It goes without saying that the carrier arrangement 200 that is illustrated rectangularly in FIG. 1 can instead be formed with a different shape. The carrier arrangement 200 can be embodied as a separate or self-supporting component, for example as a plate, or the carrier arrangement 200 can be arranged on a separate component, for example by applying its layers, as a whole or successively, to a planar substrate.

The carrier arrangement 200 is preferably intended to be arranged in an interior of a building in the wall region or in the ceiling region or both. In particular, the carrier arrangement 200 can be embodied as a cladding panel, for example a modified plasterboard panel, which is fastened, for example, in front of a raw wall of the interior or below a raw ceiling of the interior. Such a cladding panel can be referred to as an electrified drywall panel. Instead, however, the carrier arrangement 200 can be embodied as a wallpaper which is formed with a plurality of layers and is adhesively bonded to the wall and/or ceiling of the interior. In turn, as an alternative to this, individual layers of the carrier arrangement 200 or combinations of these layers can be applied in succession to a wall and/or ceiling of the interior as a substrate.

The carrier arrangement 200 schematically illustrated in FIG. 1 comprises a plurality of electrical conductor tracks 233, which are each of identical, strip-shaped and elongated design and are arranged parallel next to one another, preferably at equal distances from one another. In FIG. 1, for an implementation in the wall region, which is illustrated there by way of example, the conductor tracks 233 extend with their longitudinal directions essentially in the vertical direction with respect to the room, but this is not mandatory. The longitudinal directions of the conductor tracks 233 could instead run horizontally or with any other orientation parallel to one another in the wall surface. In another exemplary implementation in a ceiling region, which is not explicitly illustrated in FIG. 1, but can be designed analogously to the implementation in FIG. 1, the conductor tracks 233 extend in a surface or plane of the ceiling and are each arranged parallel to one another. In particular, in an implementation in the ceiling region, the conductor tracks 233 can extend in a horizontal plane, wherein however in the case of an oblique design of the room ceiling or of a region thereof, an arrangement in a plane that is oblique, that is to say inclined, with respect to the horizontal is conceivable. Within the surface or plane of the ceiling, different orientations of the mutually parallel conductor tracks 233 are conceivable.

In the carrier arrangement 200, the conductor tracks 233 are covered by a plurality of cover layers 234, 235 and 236. For example, the layer 234 can be embodied as a carrier layer that carries the conductor tracks 233. The next layer 235, viewed from the side of the room, arranged on the layer 234 can be embodied as a holding layer and can comprise a magnetic or magnetizable material, the function of which will be explained below. In some exemplary embodiments, the holding layer 235 can be produced by means of a magnetic filler.

A further layer 236 can be arranged on the layer 235, for example a colour layer that covers a surface 237 of the carrier arrangement 200 and, for example, renders possible a desired colouring and surface structure.

The layer sequence in FIG. 1 is illustrated by way of example, but other layer sequences and combinations of layers are possible, provided that conductor tracks 233 and a magnetic or magnetizable material can be accommodated in these layers. In the carrier arrangement 200 of FIG. 1, the magnetic or magnetizable material and the conductor tracks 233 are thus arranged on or in the surface 237, wherein the conductor tracks 233 are preferably covered by at least one layer of the carrier arrangement 200, for example layer 234, which provides an electrical insulation effect. In other words, the conductor tracks 233 thus run behind the surface 237 by the thicknesses of the covering layers 234-236.

In the carrier arrangement 200 of FIG. 1, the electrical conductor tracks 233 are supplied with DC voltage as a low voltage, for example an electrical voltage of up to about 48 volts, in particular about 24 volts or about 48 volts, with alternating polarity by a rail-shaped or strip-shaped feed device 240. The polarity of the conductor tracks 233 thus changes regularly from one of these to the next.

The connection to a power supply system for supplying the feed device 240 is established, for example, via an operating device 241, which is configured so as to convert the AC voltage of the power supply system of, for example, 230 V into the low voltage that is provided for supplying the conductor tracks 233.

The surface 237 thus preferably forms an inner wall surface of the room or a part thereof or an inner ceiling surface of the room or a part thereof. It goes without saying that in the room, inner wall surfaces and/or inner ceiling surfaces can be embodied in a wide variety of combinations as or with the carrier arrangement 200. One or more electrical consumers can be arranged on the surface 237 in a flexible, detachable manner, fixed magnetically, and supplied with electrical power via the carrier arrangement 200 for operating the consumer(s).

The consumers can be dimmable or non-dimmable lighting devices, such as lamps or orientable spotlights, display devices such as a TV or a monitor or a digital picture frame, a smartphone or a laptop, chargers, such as a charger for a smartphone or a laptop, or power sources for each of a further, downstream consumer. In some embodiments, the supply device can thus function as a charger. The surface 237 can thus be used in a highly flexible manner in order to attach and supply electrical consumers of a wide variety of types, wherein the consumer is not only easy to attach due to its magnetic fixing, but can also be removed and repositioned just as easily.

The electrical consumer is supplied in each case by means of a supply device 1, which can be fastened to the planar carrier arrangement 200 and can be coupled to the consumer for its electrical supply. A supply device 1 in accordance with one exemplary embodiment is described below.

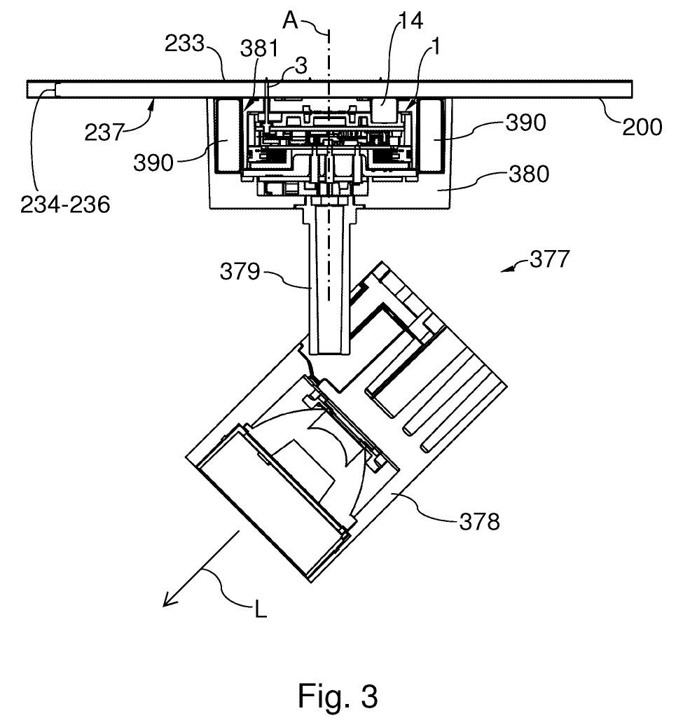

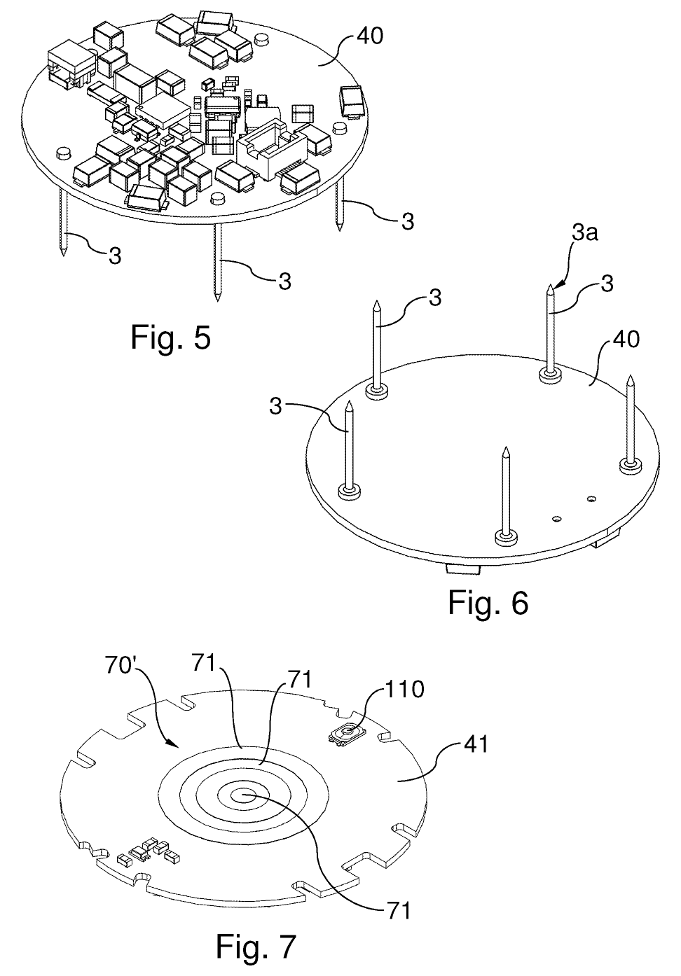

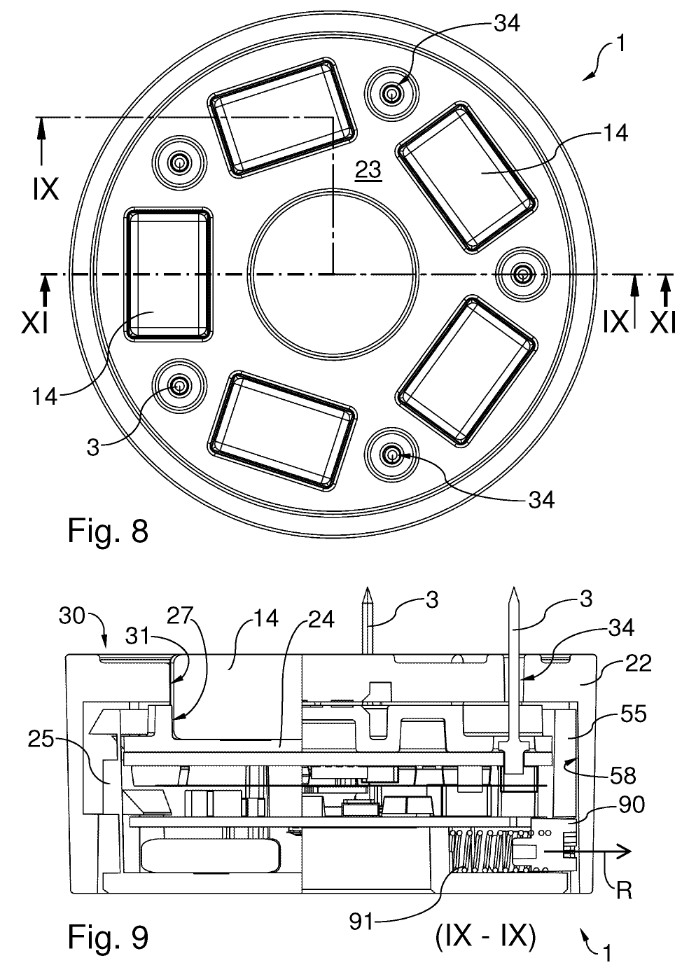

FIG. 2, 4, 8-11 illustrate the plug-like supply device 1 in different views, FIG. 3 illustrates a situation of use of the supply device 1 together with an exemplary electrical consumer 377, and FIG. 5-7 illustrate individual parts of the supply device 1.

The supply device 1 comprises a housing 2, which is embodied with an essentially circular outer contour 20, as seen in a cross section of the housing 2. The housing 2 is formed with an inner housing part 21 and an outer housing part 22, wherein the housing parts 21 and 22 are each formed on the outside with an essentially circular-cylindrical shape. In this case, the outer housing part 22 comprises an inner region in which the inner housing part 21 can be received coaxially with the outer housing part 22. In one variant, the outer housing part 22 can be embodied in the form of a slightly truncated cone on the outside, which is illustrated by way of example in the figures.

In an assembled state of the supply device 1, the inner and outer housing parts 21, 22 are coupled to one another so as to be movable relative to one another. In this case, the inner housing part 21 can be displaced along a common axial direction A of the housing parts 21, 22 relative to the outer housing part 22. In order to prevent the housing parts 21, 22 from tilting and jamming relative to one another, the inner housing part 21 is embodied with rib-like guide projections 55, which extend parallel to the axial direction A on an outer circumferential surface of the housing part 21 and interact with corresponding guide recesses 58 of the outer housing part 22 and thereby guide the inner housing part 21 during its movement relative to the outer housing part 22. Tilting, twisting and jamming of the two parts 21, 22 is thus avoided and a clean guidance is achieved.

The inner and outer housing parts 21, 22 are each formed by means of injection moulding or produced by means of 3D printing. The housing parts 21, 22 are preferably each formed with a plastic material.

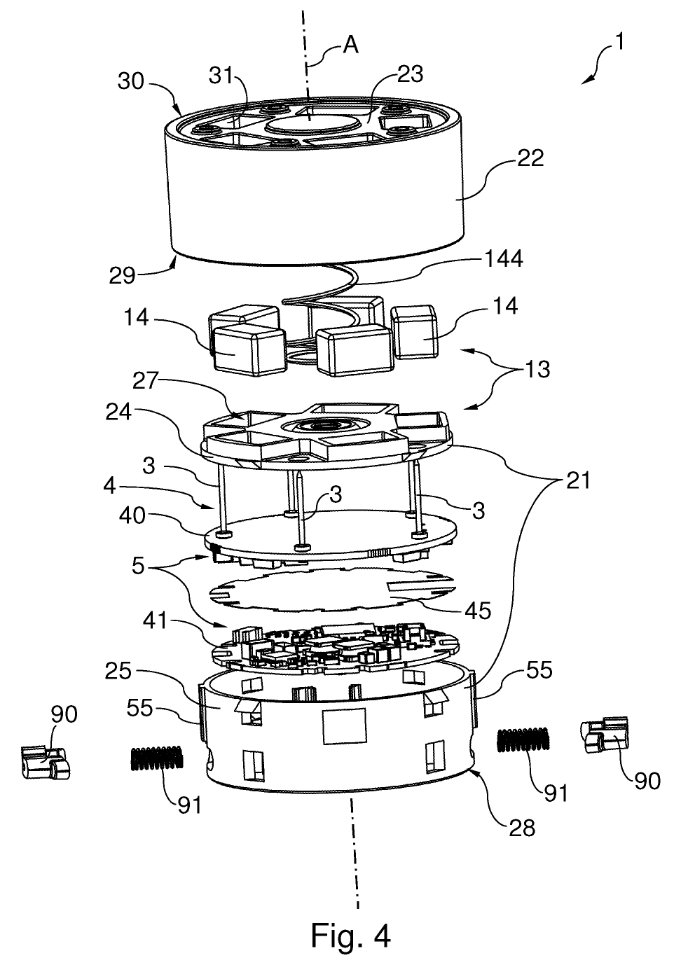

FIG. 4, for example, illustrates the structure of the supply device 1 in more detail. The outer housing part 22 is embodied essentially as a hollow, single piece, externally cylindrical element, which comprises an interrupted base 23 on an end face 30 thereof. The inner housing part 21 is formed with two individual, interconnected, for example latched, elements 24 and 25. The element 25 is embodied as a hollow body which is again essentially cylindrical on the outside and has an end-face base 26, wherein the element 25 comprises the guide projections 55 and a number of latching projections and interruptions in the region of its outer circumferential surface. The element 24 is embodied as a flat frame having an essentially circular outer circumference, provided with a plurality of magnet receiving arrangements 27, and serves as a magnet carrier 24.

In an interior of the inner housing part 21, two planar, disk-shaped circuit boards 40 and 41 are accommodated coaxially and parallel to one another. The circuit boards 40, 41 are populated with a plurality of electrical and electronic components and are electrically connected to one another by means of a contact or plug device, for example the plug-in connection device 42. The electrical and electronic components with which the circuit boards or boards 40, 41 are populated form an arrangement 5, which is electrically coupled to a plurality of contacting elements 3 that are embodied as contact needles. For this purpose, the contacting elements 3 are oriented parallel to one another and are each mechanically fixed at one end thereof on the circuit board 40 and electrically conductively connected to conductor tracks of the circuit board 40, which are not illustrated in any more detail in the figures. At their free ends 3a, which are distal in relation to the circuit board 40, the contacting elements 3 are each embodied as pointed and/or sharp.

The arrangement 5 of electrical and electronic components includes, in particular, a rectifier device and can further comprise a control device, a driver device and/or a hot-plug protection device. For example, the arrangement 5 can comprise a control device that can receive and interpret a wirelessly transmitted control signal in order to control the consumer.

Inside the inner housing part 21, the circuit boards 40 and 41 are arranged in such a way, see, for example, FIGS. 9-11, that sides of the circuit boards 40 and 41 populated with the plurality of electrical and electronic components face one another. A disk-shaped insulating element 45, for example a film-like insulating element 45, is arranged between the two circuit boards 40, 41. In this manner, the circuit boards 40, 41 can be arranged closely adjacent to one another and in a space-saving manner.

With the contacting elements 3, a first electrical contact device 4 of the supply device 1 is formed, by means of which electrical current can be absorbed by the carrier arrangement 200. The supply device 1 furthermore comprises a second electrical contact device 70, or 70' in an exemplary variant, which serves to make electrical contact with the consumer 377 for the supply thereof.

The second contact device 70, 70' is arranged on a side of the circuit board 41 facing away from the circuit board 40 and is accessible from the outside through a central opening in the base 26 of the inner housing part 21, see FIGS. 2, 10, 11. The contact device 70 is embodied with two concentric, planar contacts 71, wherein a first of the contacts 71 is embodied as a circular contact 71 and the other of the contacts 71 is embodied as an annular contact 71 concentrically surrounding the first contact. In one variant, see FIG. 7, a central circular contact 71 can be concentrically surrounded by, for example, two concentrically arranged annular contacts 71 of the contact device 70′ having different diameters. Other numbers of contacts are conceivable in further variants. Each of the contacts 71 can be contacted by a resilient pressure contact 72 of the consumer 377 in order to electrically couple the consumer 377 to the supply device 1.

In the assembled state, the magnet carrier 24 is firmly connected to the hollow body 25 and the circuit boards 40, 41 to form a whole, for example by latching latches of the magnet carrier 24 to some of the interruptions of the hollow body 25.

A magnet 14, in particular a permanent magnet, is arranged and fastened in each of the plurality of magnet receiving arrangements 27 of the magnet carrier 24. For example, the permanent magnet 14 can be adhesively bonded into the magnet receiving arrangement 27 in each case. The magnets 14 are preferably embodied in the same way. The magnet receiving arrangements 27 are provided on the magnet carrier 24 in a uniformly distributed manner in the circumferential direction about the axial direction A.

When the supply device 1 is assembled, an axially acting compression spring 144, a helical spring in the exemplary embodiment, is arranged between the housing parts 21 and 22. The spring 144 causes a spring loading of the housing parts 21, 22 relative to one another along the axial direction A.

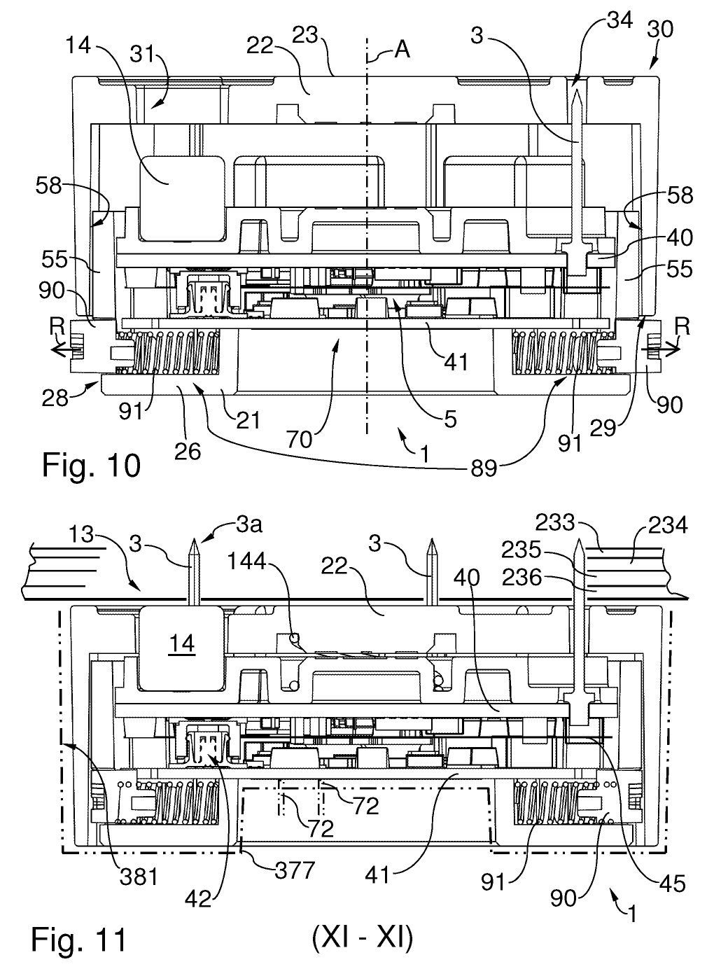

Under the action of the spring 144, the inner housing part 21 protrudes in sections from the outer housing part 22 in the axial direction A. This state is illustrated in FIGS. 2 and 10. Stops that are formed by latching inner and outer housing part 21, 22 prevent the inner housing part 21 from being pressed completely out of the outer housing part 22 under the action of the spring 144.

In the state of FIGS. 2 and 10, the contacting elements 3 are located in a non-contacting position in which they are completely received within the housing 2. By displacing the inner housing part 21 relative to the outer housing part 22 into this outer housing part, the contacting elements 3 can be displaced together with the inner housing part 21 relative to the outer housing part 22 along the axial direction A. The base 23 of the outer housing part 22 on its end face 30 is provided with recesses 34 in the form of passage openings. The recesses 34 are provided in a manner corresponding to the number and arrangement of the contacting elements 3. In the exemplary embodiment that is illustrated in the figures, the supply device comprises, by way of example, five contacting elements 3 that are arranged uniformly spaced apart along a circular path and are thus provided at the corners of a regular pentagon, and five recesses 34 that are positioned in the same way. However, other numbers and arrangements of contacting elements are alternatively conceivable.

By manually pushing the inner housing part 21 into the outer housing part 22, by means of pressure on the base 26, an extension of the contacting elements 3 on the end face 30 can be caused by the continuous recesses 34, see, for example, FIGS. 9 and 11, and the contacting elements 3 can be brought into a contacting position. The pointed and/or sharp ends 3a of the needle-shaped contacting elements 3 thus protrude from the housing 2.

In order to prevent the contacting elements 3 from being unintentionally extended from the housing 2 during the handling of the supply device 1, the supply device 1 in accordance with the exemplary embodiment is equipped with a safety arrangement 8. In a blocking configuration thereof, an extension of the contacting elements 3 is prevented in a mechanical manner.

The safety arrangement 8 comprises a manually actuable blocking and release mechanism 89, which is embodied with two blocking elements 90. The two blocking elements 90 are embodied as pressure actuation elements and are arranged on the inner housing part 21 opposite one another on a circumference of the inner housing part 21 diametrically, in other words offset by 180 degrees about the axial direction A. The two blocking elements 90 are each movable outward in a spring-loaded manner in a direction R radially with respect to the axial direction A. In particular, each of the blocking elements 90 can be displaced radially inward with respect to the inner housing part 21 against the action of a spring element 91 that is embodied as a compression spring, for example in the form of a helical spring. In other words, each of the blocking elements 90, as a type of lateral pushbutton on the inner housing part 21, can be pressed into the inner housing part 21 in the radial direction R against the action of the respective spring element 91.

The blocking elements 90 are arranged on an end section 28 of the inner housing part 21, which protrudes from the outer housing part 22 in the state of FIGS. 2 and 10, corresponding to the retracted non-contacting position of the contacting elements 3. In this case, each of the blocking elements 90 is displaceably guided on the hollow body 25 of the inner housing part 21 in the radial direction R and is thereby movably mounted.

In this manner, the blocking elements 90 are arranged in particular in such a manner that they can be pressed radially in a targeted and intentional manner by the operator or installer, for example with the aid of the thumb and index finger. If the blocking elements 90 are not pressed against the spring elements 91, i.e. are located in their non-actuated state, the blocking elements 90 protrude radially away from the inner housing part 21 over an annular edge 29 of the outer housing part 22.

In this way, each of the blocking elements 90 is embodied as a blocking body which is spring-loaded by the spring element 91 in the radial direction R and blocks the insertion of the inner housing part 21 into the outer housing part 22 and thus the extension of the contacting elements 3.

In order to bring the safety arrangement 8 into a release configuration in which the inner housing part 21 can be pushed axially into the outer housing part 22 by manual action, the operator or installer first manually actuates both of the blocking elements 90 at the same time, for example by means of the thumb and index finger, and keeps them actuated. If both blocking elements 90 are pressed in and held pressed in sufficiently in this way, the inner housing part 21 can be pressed into the outer housing part 22 and completely received therein. The release configuration of the safety arrangement 8 thus renders it possible for the contacting elements 3 to be extended.

In order to fasten an electrical consumer, of example a lamp such as the consumer 377 in FIG. 3, which is designed, for example, as a spotlight for emitting light L and is provided with a movable spotlight head 378, a connecting piece 379 and a spotlight foot 380, to the carrier arrangement 200 and to supply it electrically via this, the supply device 1 is first provided in the initial state illustrated in FIG. 2 and 10. In this state, the inner housing part 21 protrudes from the outer housing part 22 in the axial direction A. This state with contacting elements 3 retracted into the housing 2 is automatically assumed as the standard position when the supply device 1 is not attached to the carrier arrangement 200.

In order to fix the supply device 1 on the surface 237 and to achieve electrical contact with the carrier arrangement 200, the supply device 1 is placed flat with the end face 30 of the outer housing part 22, on which the housing part 22 comprises the base 23, on the planar surface 237 of the carrier arrangement 200. In this state, the blocking configuration of the safety arrangement 8 still prevents the contacting elements 3 from being extended.

The safety arrangement 8 is then brought into its release configuration by radially manually pressing in the blocking elements 90 and overcoming the radial spring force of the spring elements 91. The inner housing part 21 can now be pressed axially into the outer housing part 21 by the operator or installer by means of manual action on the base 26, overcoming the axial spring force that is applied by the spring 144. As a result, the contacting elements 3 move axially out of the housing 2 through the recesses 34, pierce into the surface 237 of the carrier arrangement 200, and pierce through the cover layers 234, 235 and 236.

In this case, at least two of the contacting elements 3 penetrate into or penetrate through one of the conductor tracks 233 in each case. The spacing of the conductor tracks 233 in the direction transverse to their longitudinal extent, the width of the conductor tracks 233 and the dimensions of the contacting elements 3, as well as the arrangement and spacing of the contacting elements 3 from one another on the supply device 1, are selected relative to one another in such a way that at least one of the contacting elements 3 contacts a conductor track 233 of the polarity (plus) and at least one further of the contacting elements 3 contacts a conductor track 233 of the polarity (minus) during the piercing process described and comes into electrically conductive contact with it. The contacting elements 3 are now located in their contacting position.

Depending on the orientation and placement of the supply device 1 on the surface 237, more than two of the contacting elements 3 can also come into contact with one and the same polarity. The arrangement 5 of the electrical and electronic components, in particular the rectifier device thereof, is configured in such a way that, irrespective of the positioning and orientation of the supply device 1 on the surface 237, the contacts 71 of the second electrical contact device 70 or 70’ are always each subjected to a voltage at a polarity that is intended for contacting by the consumer 377, insofar as at least two conductor tracks 233 of different polarity are contacted by the first electrical contact device 4.

The safety arrangement 8 thus renders possible a pleasant and safe handling of the supply device 1. The end regions 3a of the contacting elements 3, which are embodied as pointed and/or sharp for piercing, can only be extended from the housing 2 when the operator or installer presses the blocking elements 90 in a targeted and intentional manner. Damage to surfaces with inadvertently extended contacting elements 3, or unpleasant contact of the hand of the operator or installer with these contacting elements, is reliably avoided.

If the inner housing part 21 is completely pressed into the outer housing part 22, see, for example, FIGS. 9 and 11, the magnets 14 that are moved along with the inner housing part 21 are arranged close to the surface 237 and are in attractive interaction with the magnetic or magnetizable material of the carrier arrangement 200. In this manner, the supply device 1 is fixed to the carrier arrangement 200 in a magnetically detachable manner. A fastening device 13 for the supply device 1 is thus formed with the permanent magnets 14, which are fastened in the magnet receiving arrangements 27. In this case, the base 23 on the end face 30 of the outer housing part 22 is provided with interruptions 31, which correspond in size, shape and position to the magnet 14, so that this magnet can interact as directly as possible with the carrier arrangement 200. In this manner, the magnets 14 can be guided close to the surface 237 and can each be inserted in sections into one of the interruptions 31 during the movement of the inner housing part 21.

After mounting the supply device 1 at the desired location on the surface 237, the consumer 377, illustrated by way of example in FIG. 3, is placed on the supply device 1. For this purpose, the consumer 377 is equipped, in FIG. 3 in the region of the spotlight foot 380, with a recess 381, which comprises a substantially cylindrical or slightly truncated cone shape with a circular inner cross section. The recess 381 is designed and dimensioned in such a way that the housing 2 of the supply device 1 can be received completely and fittingly in the recess 381 when the contacting elements 3 are located in their contacting position. During placement, the resilient pressure contacts 72 of the consumer 377 simultaneously come into electrically conductive contact with the circular and annular contacts 71.

In this case, the housing 2 that is received in the recess 381 is enclosed by the consumer 377 in the circumferential direction thereof and is received essentially completely in the axial direction A. As an alternative, it could be provided that the housing 2 can be received in the recess 381 only with a part of its axial extension, so that the housing overlaps the consumer 377 in the axial direction A.

The consumer 377 is, by way of example in the region of the spotlight foot 380, likewise equipped with further magnets 390, in particular permanent magnets, which make it possible to hold the consumer 377 detachably on the carrier arrangement 200 by interaction with the magnetic or magnetizable material of the carrier arrangement 200.

Due to the circular outer cross-section of the supply device 1 in cooperation with the circular inner cross-section of the recess 381, the consumer 377 can be rotated around the supply device 1 as desired and without restrictions, which contributes to a high degree of flexibility in use. The concentric arrangement of the contacts 71, coaxial to the axial direction A, renders it possible for the consumer 377 to rotate unhindered about the housing 2 without interrupting the power supply of the consumer 377, wherein the pressure contacts 72 can slide on the contacts 71.

After piercing into the surface 237, the contacting elements 3 are held outside the housing 2 against the force of the spring 144 essentially by frictional forces in the layers of the carrier arrangement 200 and the magnetic force of the magnets 14. In addition, after the consumer 377 has been placed on, it can also contribute, in its state in which it is magnetically fixed to the surface 237, to the inner housing part 21 remaining pressed into the outer housing part 22.

If, after the consumer 377 has been removed, the supply device 1 is removed from the surface 237, for example in order to place it again in another way, then the contacting elements 3 are automatically drawn into the housing 2 by the action of the spring 144 on the housing parts 21, 22. The spring 144 thus forms a restoring device, which pre-stresses the contacting elements 3 in the direction of the non-contacting position. Pointed and/or sharp regions 3a of these are thus in turn securely accommodated in the housing 2. At the same time, the end region 28 of the inner housing part 21, which previously faced the consumer 377, moves again relative to the outer housing part 22 into a position in which it protrudes beyond the edge 29. In this case, the safety arrangement 8 automatically resumes its blocking configuration in that the blocking elements 90 project radially outwards beyond the edge 29 under the action of their spring load. A renewed extension of the contacting elements 3 is in turn only possible in a targeted and intentional manner, and an accidental extension is prevented.

The above-described automatic retraction of the contacting elements 3 and transfer of the safety arrangement 8 into its blocking configuration also occurs if the supply device 1 should unintentionally detach from the surface 237 due to carelessness, accidental excessive application of force, impact or the like.

The supply device 1 is additionally equipped with a display device 110 that is designed with an LED device and is arranged on the circuit board 41. The display device 110 is configured to signal to the operator or installer that at least two contacting elements 3 contact conductor tracks 233 of different polarity, so that electrical energy can be obtained from the carrier arrangement 200. The LED device of the display device 110 is visible from the side of the base 26 of the inner housing part 21, for which purpose the base 26 is provided with a passage opening, the position of which corresponds to that of the display device 110.

In further variants of the exemplary embodiment described above with reference to the figures, the second contact device 70 of the supply device 1 is not necessarily embodied with flat, concentric circular and annular contacts 71. Instead, the second contact device 70 could be formed with a component of a plug connection. The plug connection can be, for example, a USB plug connection or a coaxial DC plug connection. For example, the second contact device of the supply device 1 can be designed with a USB-C socket or a coaxial DC socket.

In the exemplary embodiment illustrated in the figures, a lamp is advantageously placed on the supply device 1 as the consumer 377. This placement is also possible if the consumer is designed differently, for example as a display device such as a monitor, as a digital picture frame or as a television. In the case of larger consumers, a plurality of supply devices 1 can be used if required.

However, in other exemplary embodiments, placing the consumer 377 on the supply device 1 is not mandatory. In particular, in an embodiment of the second contact device with a component of a plug connection, as described above, the consumer can be connected to the second contact device, for example via a cable. In such a variant, the supply device 1 can be used, for example, to supply a smartphone or a laptop, or a charger for a smartphone or laptop, with electrical energy.

Although the invention has been fully described above on the basis of preferred exemplary embodiments, it is not limited thereto, but can be modified in a variety of ways.

### LIST OF REFERENCE NUMERALS

1 Supply device

2 Housing

3 Contacting element

3a End

4 First electrical contact device

5 Arrangement of electrical and/or electronic components

8 Safety arrangement

13 Fastening device

14 Magnet

20 Outer contour

21 Inner housing part

22 Outer housing part

23 Interrupted base

24 Magnet carrier

25 Hollow body

26 Base

27 Magnet receiving arrangement

28 End section

29 Edge

30 End face

31 Interruption

34 Recess

40 Circuit board

41 Circuit board

42 Plug-in connection device

45 Insulating element

55 Guiding projection

58 Guiding recess

70, 70' Second electrical contact device

71 Ring contact

72 Pressure contact

89 Blocking and release mechanism

90 Blocking element

91 Spring element

110 Display device

144 Spring

200 Carrier arrangement

233 Conductor track

234 First layer

235 Second layer

236 Third layer

237 Surface

240 Feed device

241 Operating device

377 Consumer

378 Spotlight head

379 Connecting piece

380 Spotlight foot

381 Recess

390 Magnet

A Axial direction

L Light

R Radial direction

1. Supply device (1) for fastening to a planar carrier arrangement (200) having electrical conductor tracks (233);
wherein the supply device (1) comprises a housing (2), contacting elements (3) and an arrangement (5) of electrical and/or electronic components that is electrically coupled to the contacting elements (3), and the supply device can be or is coupled to an electrical consumer (377) for the supply thereof;
wherein the contacting elements (3) are each provided for piercing into a surface (237) of the carrier arrangement (200) and are each embodied as pointed and/or sharp;
wherein the contacting elements (3) can be brought into a non-contacting position in which the contacting elements (3) are received in the housing (2);
wherein the contacting elements (3) can be brought into a contacting position and for this purpose can be extended out of the housing (2) by means of manual action on the supply device (1) in order to pierce into the surface (237) of the carrier arrangement (200) by means of the contacting elements (3) and to bring at least two of the contacting elements (3) into contact with in each case one of the conductor tracks (233); and
wherein the supply device (1) comprises at least one safety arrangement (8), by means of which an extension of the contacting elements (3) is mechanically prevented in a blocking configuration thereof.

2. Supply device according to claim 1, wherein the safety arrangement (8) can be brought manually into a release configuration in which the extension of the contacting elements (3) is rendered possible.

3. Supply device according to claim 1, wherein the supply device (1) includes a restoring device (144), which is embodied so as to directly or indirectly pre-stress the contacting elements (3) at least in their contacting position for an automatic assumption of the non-contacting position; and/or wherein the extension of the contacting elements (3) by means of the manual action comprises overcoming at least one spring force.

4. Supply device according to claim 1, wherein the safety arrangement (8) is configured so as to automatically assume the blocking configuration when the contacting elements (3) are located in their non-contacting position.

5. Supply device according to claim 1, wherein the housing (2) comprises an inner housing part (21) and an outer housing part (22), wherein the inner and outer housing parts (21, 22) are coupled to one another so as to be movable relative to one another and the contacting elements (3) can be extended out of the housing (2) by means of a movement of the inner and outer housing parts (21, 22) relative to one another by means of the manual action.

6. Supply device according to claim 5, wherein the contacting elements (3) can be displaced together with the inner housing part (21) relative to the outer housing part (22), in particular along an axial direction (A) of the housing (2).

7. Supply device according to claim 5, wherein the inner housing part (21) protrudes in sections from the outer housing part (22) in the non-contacting position of the contacting elements (3).

8. Supply device according to claim 5, wherein the contacting elements (3) can be extended out of the outer housing part (22) on an end face (30) thereof.

9. Supply device according to claim 5, wherein the safety arrangement (8) comprises a manually actuable blocking and release mechanism (89), the actuation of which brings the safety arrangement (8) into its release configuration and renders it possible to move the inner housing part (21) relative to the outer housing part (22), in particular to move it into the outer housing part (22), preferably to press it in, more preferably to press it in such a manner that the inner housing part (21) is essentially completely received in the outer housing part (22).

10. Supply device according to claim 9, wherein the blocking and release mechanism (89) is embodied with at least one spring-loaded, movable blocking element (90), by means of which a movement of the inner housing part (21) relative to the outer housing part (22), in particular a manual pressing of the inner housing part (21) into the outer housing part (22), can be blocked, wherein the blocking element (90) can be moved manually against the spring load for release.

11. Supply device according to claim 10, wherein the blocking and release mechanism (89) comprises at least two such blocking elements (90) which are arranged such that they can be moved in a spring-loaded manner on a circumference of the inner housing part (21) and are embodied as pressure actuation elements, in particular two such blocking elements (90) which are arranged on opposite sides of the inner housing part (21).

12. Supply device according to claim 10, wherein the blocking element(s) (90) is/are arranged on an end section (28) of the inner housing part (21), which protrudes from the outer housing part (22) in a state in which the contacting elements (3) are located in their non-contacting position, and protrudes away from the inner housing part (21) over an edge (29) of the outer housing part (22) in the non-actuated state.

13. Supply device according to claim 10, wherein the blocking element(s) (90) is/are each embodied as a blocking body which is mounted on or in the inner housing part (21) such that it can be displaced essentially radially with respect to the inner housing part (21) and is/are spring-loaded radially outward by means of a spring element (91) for protrusion in the direction (R).

14. Supply device according to claim 5, wherein the inner housing part (21) comprises guide projections (55), which interact with corresponding guide recesses (58) of the outer housing part (22) and thereby guide the inner housing part (21) during its movement relative to the outer housing part (22) during the extension or retraction of the contacting elements (3); and/or wherein the inner housing part (21) and the outer housing part (22) are spring-loaded relative to one another by means of at least one axially acting spring (144) that is arranged between the housing parts (21, 22); and/or wherein the arrangement (5) of electrical and/or electronic components is provided on a circuit board or a plurality of circuit boards (40, 41), wherein the circuit board(s) (40, 41) are fastened to the inner housing part (21) and are received in particular in the inner housing part (21).

15. Supply device according to claim 1, wherein the supply device (1) comprises a fastening device (13), which renders it possible for the supply device (1) to be detachably fixed to the carrier arrangement (200), in particular in a state in which the contacting elements (3) are located in the contacting position.

16. Supply device according to claim 15, wherein the fastening device (13) is embodied with one or more magnets (14), in particular with one or more permanent magnets, which can interact with a magnetizable or magnetized material on or in the surface (237) of the carrier arrangement (200).

17. Supply device according to claim 1, wherein the housing (2) comprises a round, in particular circular, outer contour; and/or wherein, when the contacting elements (3) are located in their contacting position, the housing (2) can be received in a round recess of the consumer (377) and, in particular, the housing (2) that is received in the round recess of the consumer (377) is enclosed by the consumer (377) in a circumferential direction of the housing (2) and overlaps the consumer (377) in an axial direction (A) of the housing (2) or is received essentially completely in the round recess of the consumer (377) in the axial direction (A).

18. Supply device according to claim 1, wherein the housing (2) is provided with recesses (34), through which the contacting elements (3) can be extended by means of the manual action; and/or wherein the contacting elements (3) are embodied as contact needles; and/or wherein the electrical conductor tracks (233) of the carrier arrangement (200) are covered by means of one or more cover layer(s) (234-236) of the carrier arrangement (200) and the contacting elements (3) are each embodied for piercing through the cover layer (234-235) or cover layers (234-236).

19. Supply device according to claim 1, wherein the supply device (1) comprises a first electrical contact device (4), which is formed with the contacting elements (3), and comprises a second electrical contact device (70; 70') for contacting and supplying the consumer (377).

20. Supply device according to claim 19, wherein the second contact device (70; 70') is embodied with concentric circular or annular contacts (71), which can each be contacted by means of a resilient pressure contact (72) of the consumer (377), in particular in such a manner that an unhindered rotation of the consumer (377) about the housing (2) of the supply device (1) is rendered possible without interrupting the power supply of the consumer (377).
